(19) United States
(12) Patent Application Publication
(10) Pub. No.: US 2010/0070063 A1
(43) Pub. Date: Mar. 18, 2010

(54) PRODUCTION SEQUENCE DETERMINATION SUPPORT METHOD, PRODUCTION SEQUENCE DETERMINATION SUPPORT DEVICE, AND COMPUTER-READABLE STORAGE MEDIUM FOR COMPUTER PROGRAM

(75) Inventor: Yousuke SHIMODA, Takamatsu (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/480,905

(22) Filed: Jun. 9, 2009

(30) Foreign Application Priority Data
Sep. 12, 2008 (JP) JP2008-235347

(51) Int. Cl. G05B 19/042

(52) U.S. Cl. 700/103; 700/18

(57) ABSTRACT

A production sequence determination support method is provided in which a computer is caused to perform determining types of specifications of the plurality of first products, displaying a screen for a user to specify individual priorities for the types of specifications, each of the priorities of the types of specifications being to produce one or more of the plurality of first products having the type of specifications, storing the priorities of the types of specifications specified by the user, determining the production sequence of the plurality of first products by sorting the plurality of first products in descending order of the priorities of the types of specifications thus stored, and displaying the production sequence of the plurality of first products thus determined.

### CROSS-REFERENCE TO RELATED APPLICATION

This application is based upon and claims the benefit of priority of the prior Japanese Patent Application No. 2008-235347, filed on Sep. 12, 2008, the entire contents of which are incorporated herein by reference.

### FIELD

The embodiments discussed herein are related to a method, a device, and the like for supporting determination of a production sequence of products.

### BACKGROUND

In order to produce a plurality of products efficiently during a predetermined period, it is important to determine efficient sequencing of units to be produced in an assembly line. Stated differently, it is important to devise a production sequence of products.

For example, in a manufacturing site to produce doors having different widths, adjusting a cutting tool is easier in the case where doors are produced in order of increasing width from one having a small width or in the reverse order than in the case where doors are produced at random. Accordingly, the former case can reduce the time for adjusting the cutting tool compared to the latter case, thereby leading to efficient manufacturing.

There have been proposed systems or devices for performing production planning using a computer.

One of the systems is to create a production plan for determining the manufacture order and manufacture period of items in an assembly line. The production plan is created by incorporating a rule for creating the production plan that has been found out by a data mining method into facility capacity setting at the time of creating the production plan, and applying the rule to specification information of the item (see Japanese Laid-open Patent Publication No. 2003-015717).

One of the devices includes a rule base, a production instructing means, and a learning means. The rule base stores production instruction rules indicating the order of items to be produced and an item for which instructions for production are preferentially given. The production instructing means receives production schedule data for the items and parts delivery data for parts forming the items, obtains at least the order and quantity of the items to be produced based on the production schedule data and the parts delivery data in accordance with the production instruction rules, and displays the order and quantity of the items to be produced in the form of vector. The learning means learns the production instruction rules applied by the production instructing means, and selects the identical production instruction rule for similar production schedule data and parts delivery data (see Japanese Laid-open Patent Publication No. 7-021263).

Another one of the systems includes a knowledge base, a database, an inference engine, a production schedule report preparation means, a production schedule report display means, and a production schedule report correction means. The knowledge base stores information obtained by turning predetermined knowledge into rules. The database stores a variety of required data. The inference engine contains therein a predetermined program including a mechanism for integrating, operating, and inference-executing the knowledge stored in the knowledge base. The production schedule report preparation means prepares a predetermined production schedule report by supplying the knowledge base and the database to the inference engine. The production schedule report display means formulates the production schedule report to a predetermined pattern and displays the result on a screen. The production schedule report correction means determines a final production instruction report by adjusting the production schedule report displayed on the screen by an operator in an interactive manner (see Japanese Laid-open Patent Publication No. 7-200680).

As described above, there has been proposed a technique for compiling a database of production sequence rules and performing production planning based thereon. Appropriate update of the database has also been proposed.

However, it is difficult to establish an optimized rule for determining a production sequence of products. In particular, in the case where products have a variety of attributes such as a color, a design, a size and an option, it is hard to define an optimized rule for determining a production sequence of products. If the number of attributes is small, it is not so difficult for a computer to execute a process for defining an optimized rule. However, increase in the number of attributes complicates algorithms suddenly.

### SUMMARY

According to an aspect of the invention (embodiment), a production sequence determination support method is a method for determining a production sequence of a plurality of first products to be produced. The production sequence determination support method includes causing a computer to perform the following: determining types of specifications of the plurality of first products, displaying a screen for a user to specify individual priorities for the types of specifications, each of the priorities of the types of specifications being to produce one or more of the plurality of first products having the type of specifications, storing the priorities of the types of specifications specified by the user, determining the production sequence of the plurality of first products by sorting the plurality of first products in descending order of the priorities of the types of specifications thus stored, and displaying the production sequence of the plurality of first products thus determined.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a network including a production sequence numbering system;

FIG. 2 is a diagram illustrating an example of the hardware configuration of a production sequence numbering system;

FIG. 3 is a diagram illustrating an example of the functional configuration of a production sequence numbering system;

FIG. 4 is a diagram illustrating an example of a production plan table;

FIG. 5 is a diagram illustrating an example of a production sequence condition master;

FIG. 6 is a flowchart illustrating an example of the flow of a tentative production sequence determination process;

FIG. 7 is a diagram illustrating an example of grouping of specifications;

FIG. 8 is a diagram illustrating an example of a production sequence modification screen;

FIG. 9 is a flowchart illustrating an example of the flow of a master registration process;

FIG. 10 is a diagram illustrating an example of a production sequence modification screen;

FIG. 11 is a diagram illustrating an example of a production sequence condition master;

FIG. 12 is a flowchart illustrating an example of the flow of a production sequence determination process;

FIG. 13 is a diagram illustrating an example of a production sequence screen;

FIG. 14 is a diagram illustrating an example of a production plan table;

FIG. 15 is a diagram illustrating an example of a tentative production sequence;

FIG. 16 is a diagram illustrating an example of a production sequence modification screen;

FIG. 17 is a diagram illustrating an example of a variation of the production sequence modification screen;

FIG. 18 is a flowchart illustrating an example of the flow of a priority record updating process;

FIG. 19 is a diagram illustrating an example of sorting of production sequence by an employee;

FIG. 20 is a diagram illustrating an example of a production sequence condition master; and

FIG. 21 is a flowchart illustrating an example of the overall processing flow of a production sequence numbering system.

### DESCRIPTION OF EMBODIMENTS

Preferred embodiments of the present invention will be explained with reference to accompanying drawings.

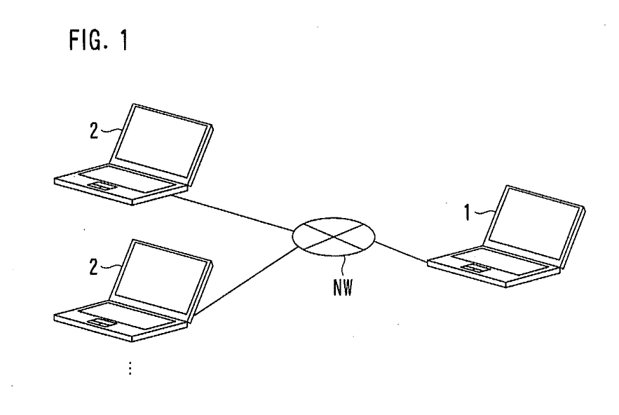

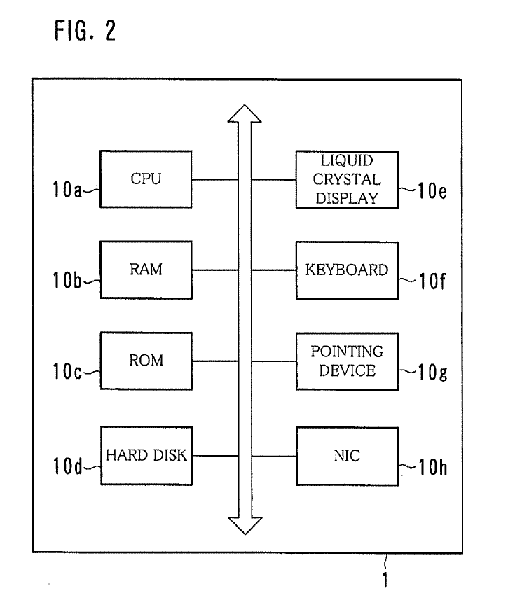

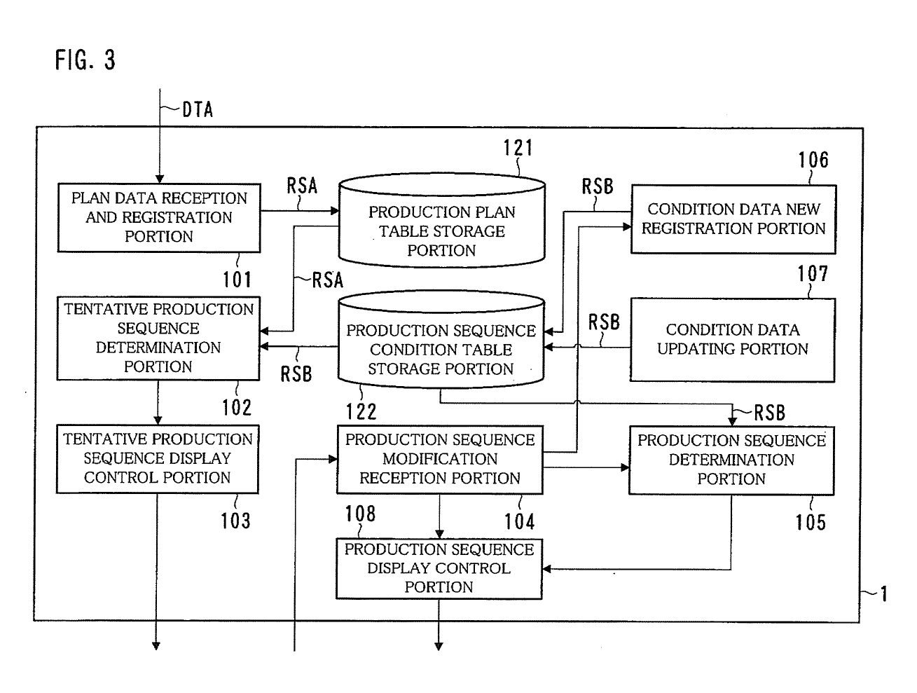

FIG. 1 is a diagram illustrating an example of a network including a production sequence numbering system 1; FIG. 2 is a diagram illustrating an example of the hardware configuration of the production sequence numbering system 1; and FIG. 3 is a diagram illustrating an example of the functional configuration of the production sequence numbering system 1.

The production sequence numbering system 1 illustrated in FIG. 1 performs a process for determining in which order predetermined products are to be produced during a predetermined period. That is, the production sequence numbering system 1 determines a production sequence of products. The production sequence numbering system 1 is described below, taking an example of a case in which a daily production sequence of doors is determined at a factory X.

Referring to FIG. 1, the production sequence numbering system 1 is configured to be connected, via a communication line NW, to personal computers 2 of ordering parties from each of which an order originates. The Internet, a public line, a dedicated line, or the like may be used as the communication line NW.

Referring to FIG. 2, the production sequence numbering system 1 is configured of a Central Processing Unit (CPU) 10a, a Random Access Memory (RAM) 10b, a Read Only Memory (ROM) 10c, a hard disk 10d, a liquid crystal display 10e, a keyboard 10f, a pointing device 10g, a Network Interface Card (NIC) 10h, and the like.

The liquid crystal display 10e serves to display a variety of screens such as a screen for an employee of the factory X, who is hereinafter referred to as simply an “employee”, to confirm specifications of a product for which an order has been placed and the quantity of the product, and a screen for the employee to confirm and modify a production sequence of products.

The keyboard 10f and the pointing device 10g are used for the employee to issue a command to the production sequence numbering system 1, and to specify a modification to the production sequence.

The NIC 10h is a device for communicating with a device, for example, the personal computer 2 using a protocol such as Transmission Control Protocol/Internet Protocol (TCP/IP).

The ROM 10c and the hard disk 10d store programs and data for implementing, as illustrated in FIG. 3, functions of a plan data reception and registration portion 101 (hereinafter referred to as a plan data reception/registration portion 101), a tentative production sequence determination portion 102, a tentative production sequence display control portion 103, a production sequence modification reception portion 104, a production sequence determination portion 105, a condition data new registration portion 106, a condition data updating portion 107, a production sequence display control portion 108, a production plan table storage portion 121, a production sequence condition table storage portion 122, and so on. These programs and data are loaded into the RAM 10b as necessary, whereupon the programs are executed by the CPU 10a.

A personal computer, a workstation, a server machine, or the like is used as the production sequence numbering system 1.

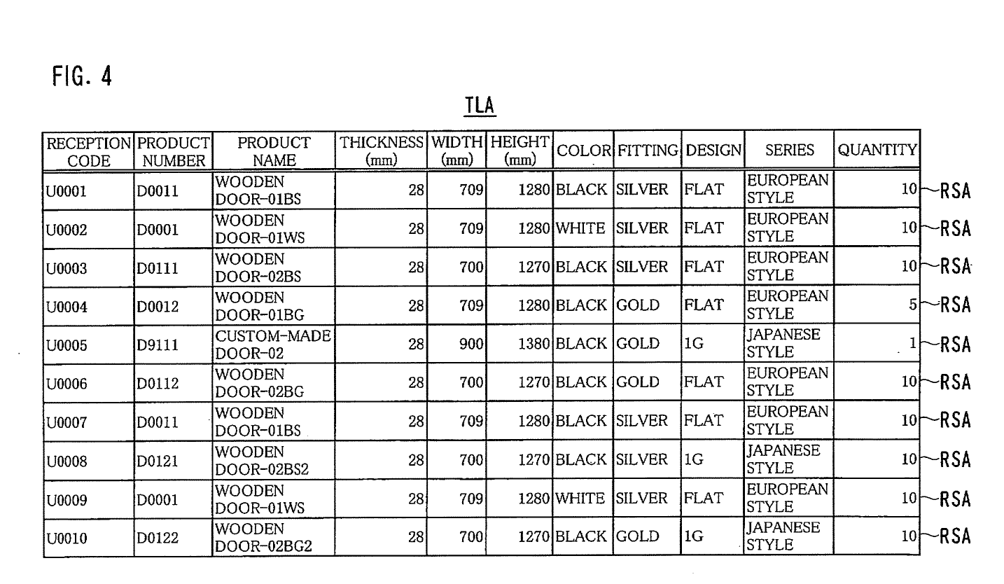

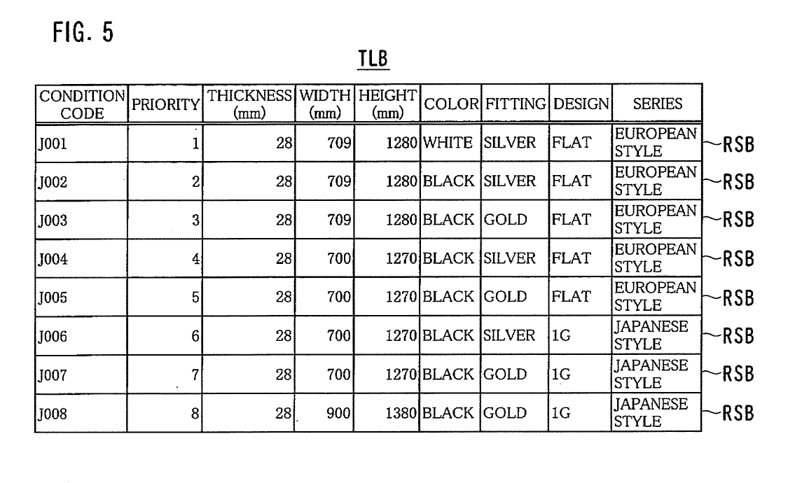

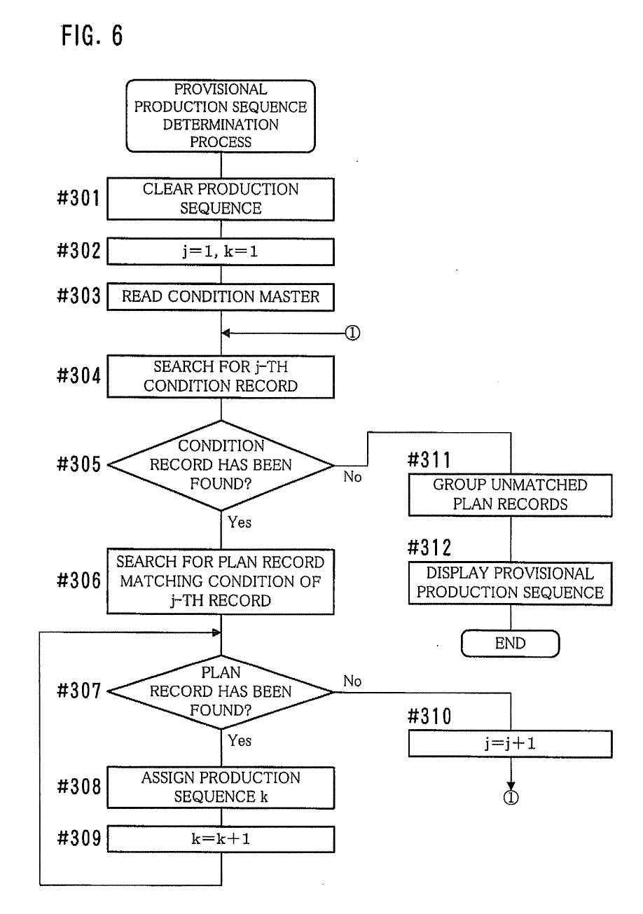

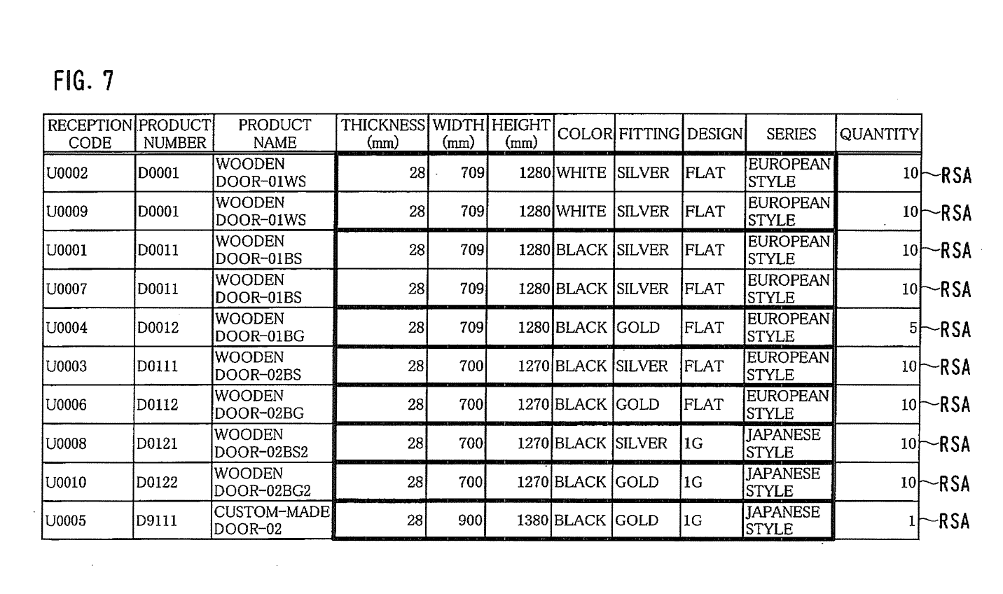

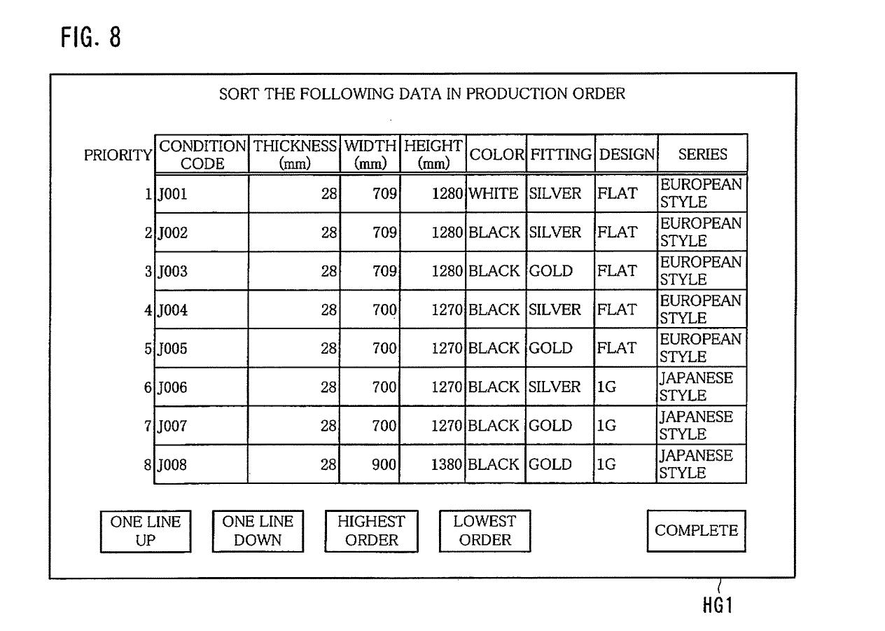

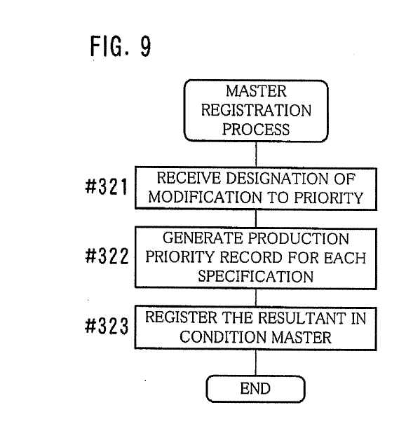

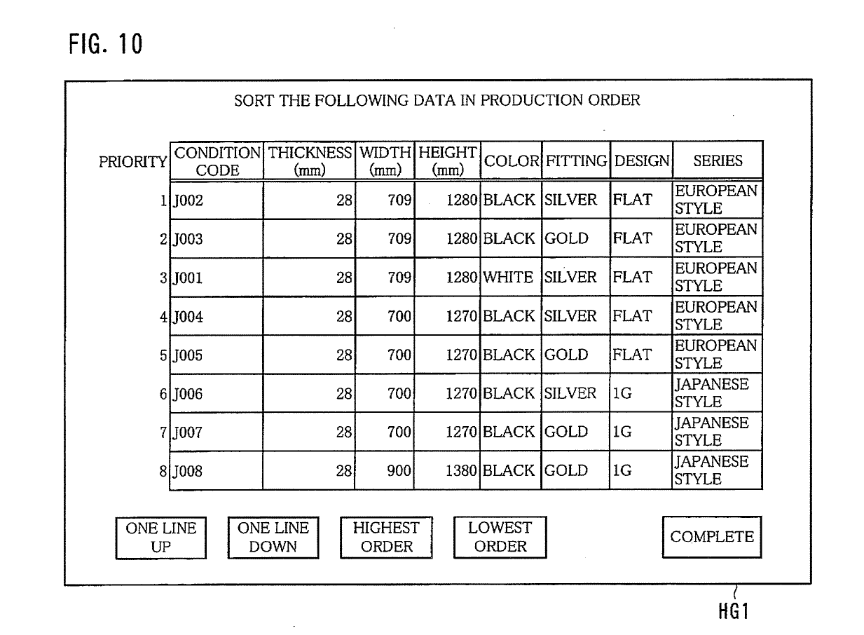

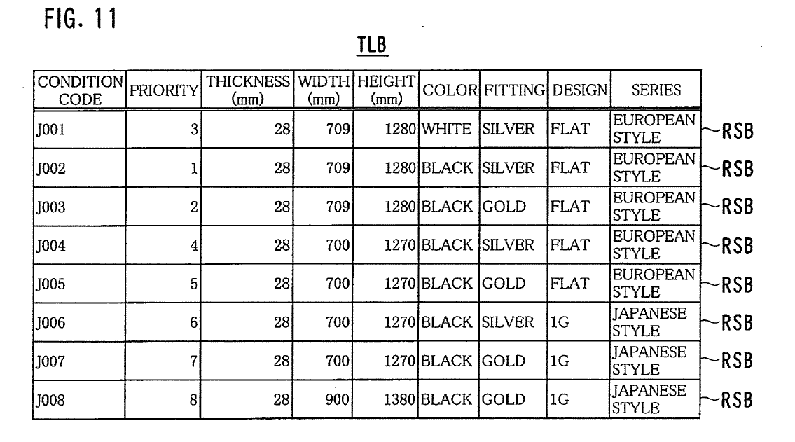

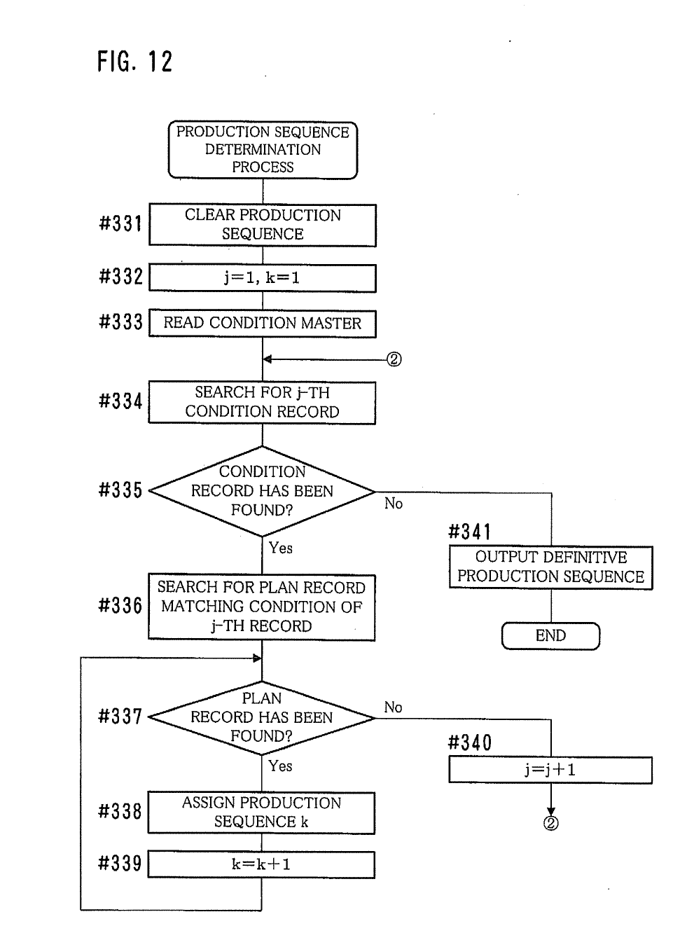

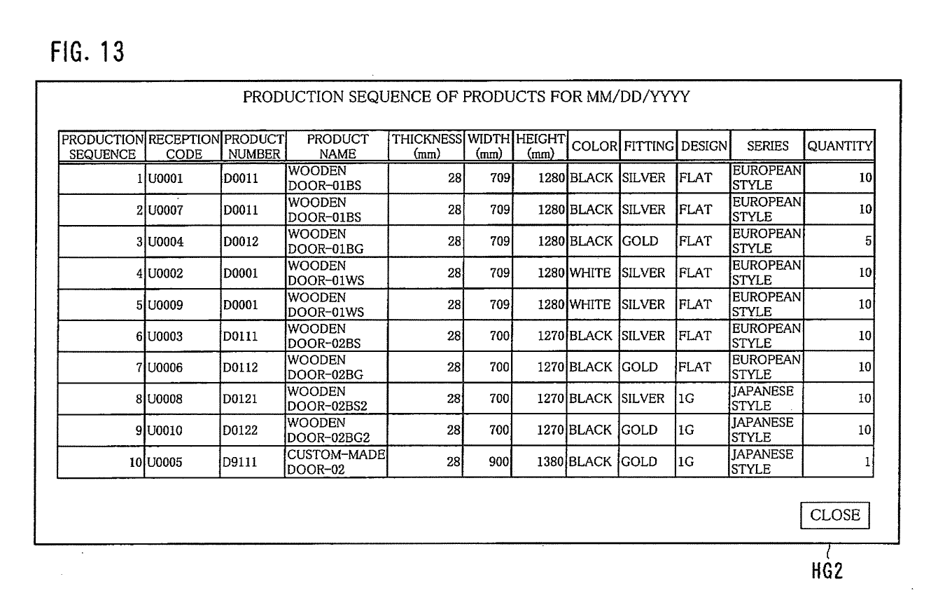

FIG. 4 is a diagram illustrating an example of a production plan table TLA; FIG. 5 is a diagram illustrating an example of a production sequence condition master TLB; FIG. 6 is a flowchart illustrating an example of the flow of a tentative production sequence determination process; FIG. 7 is a diagram illustrating an example of grouping of specifications; FIG. 8 is a diagram illustrating an example of a production sequence modification screen HG1; FIG. 9 is a flowchart illustrating an example of the flow of a master registration process; FIG. 10 is a diagram illustrating an example of the production sequence modification screen HG1; FIG. 11 is a diagram illustrating an example of a production sequence condition master TLB; FIG. 12 is a flowchart illustrating an example of the flow of a production sequence determination process; and FIG. 13 is a diagram illustrating an example of a production sequence screen HG2.

The following is a detailed description of functions and process details of the individual portions included in the production sequence numbering system 1 illustrated in FIG. 3.

Referring to FIG. 3, the production plan table storage portion 121 stores the production plan table TLA, for each day, in which production plan records RSA are stored as illustrated in FIG. 4. Each of the production plan records RSA indicates a product number, a product name, specifications (thickness, width, height, color, fitting, design and series), quantity, and the like of a product to be produced on that day. As described below, the production plan record RSA is generated every time an order is received from an ordering party. As a result, a plurality of production plan records RSA indicating the identical product are sometimes stored in the production plan table TLA for the same day. By way of distinguishing such production plan records RSA from each other, a unique reception code is given to each of the production plan records RSA.

The production plan record RSA is generated by the plan data reception/registration portion 101 in the following manner and is registered (stored) in the production plan table storage portion 121.

The plan data reception/registration portion 101 receives, from the personal computer 2 of an ordering party, order data DTA including a product number, a product name, specifications, and a production volume (quantity) of a product. The plan data reception/registration portion 101 determines a date on which the product is to be produced, and issues a unique reception code in accordance with production rules of the factory X. Then, the plan data reception/registration portion 101 generates a production plan record RSA indicating the reception code thus issued, the product number, the product name, the specifications, and the quantity included in the order data DTA received as discussed above, and stores the production plan record RSA thus generated in the production plan table TLA for the date thus determined.

Alternatively, upon receipt of an order from an ordering party via telephone or facsimile, an employee operates the keyboard 10f and the pointing device 10g to enter order data DTA. Responding to this, the production sequence numbering system 1 determines a production date, issues a reception code, and generates a production plan record RSA as with the case described above. Then, the production plan record RSA thus generated is stored in a production plan table TLA for the production date thus determined.

As illustrated in FIG. 5, the production sequence condition table storage portion 122 stores the production sequence condition master TLB indicating which product is to be produced preferentially based on product specifications. A production priority record RSB is stored for each set of product specifications in the production sequence condition master TLB.

By way of distinguishing the production priority records RSB from each other, a unique condition code is given to each of the production priority records RSB. Each of the production priority records RSB includes an order of precedence (hereinafter, referred to as a “priority”) based on which a product corresponding to the specifications is produced. The smaller the priority number is, the earlier the product is produced. A method for generating and updating the production priority record RSB is described later.

The tentative production sequence determination portion 102 performs a process for provisionally determining a production sequence of products to be produced on a certain day. The tentative production sequence display control portion 103 performs a process for displaying, on the liquid crystal display 10e, a provisional production sequence determined by the tentative production sequence determination portion 102. An employee may modify the provisional production sequence optionally.

The production sequence modification reception portion 104 performs a process for receiving the modification to the production sequence specified by the employee. The production sequence determination portion 105 performs a process for determining a final production sequence of products to be produced on a certain day. The production sequence display control portion 108 performs a process for displaying, on the liquid crystal display 10e, a final production sequence of products determined by the production sequence determination portion 105.

The condition data new registration portion 106 performs a process for generating a production priority record RSB depicting new specifications, and registering the production priority record RSB thus generated in the production sequence condition master TLB. The condition data updating portion 107 performs a process for updating priorities indicated in the existing production priority records RSB.

The following is a description of the detailed processes performed by the tentative production sequence determination portion 102 through the condition data updating portion 107 with reference to flowcharts. Note that steps of the process are different between a day on which production is carried out for the first time after the start of operation of the production sequence numbering system 1, i.e., the first day, and the second day and later. Accordingly, the descriptions are separated into steps of the process for the first day and steps of the process for the second day and later.

### [Steps of the Process of Determining a Production Sequence for the First Day]

The tentative production sequence determination portion 102 performs, at a predetermined timing, a process for determining a provisional production sequence of products to be produced on a certain day. The tentative production sequence determination portion 102 performs such a process, for example, a predetermined time prior to the production start time of the day.

To be more specific, referring to FIG. 6, the tentative production sequence determination portion 102 performs an initialization process if necessary (#301 and #302). For example, if data on production sequence that was planned (determined) previously still remains, the tentative production sequence determination portion 102 deletes such data. Further, the values of variables j and k are reset to “1”.

The tentative production sequence determination portion 102 calls the production sequence condition master TLB (see FIG. 5) from the production sequence condition table storage portion 122 (#303). The tentative production sequence determination portion 102 searches, in the production sequence condition master TLB, for a production priority record RSB to which the first priority is given (#304). Upon determination of a production sequence for the first day, however, no production priority records RSB are stored in the production sequence condition master TLB (No in #305). Thus, the tentative production sequence determination portion 102 bypasses the process in Step #306 through Step #310, and proceeds to the process in Step #311.

The tentative production sequence determination portion 102 groups, on a specification-by-specification basis, production plan records RSA that do not match, in Step #306, any of the specifications (conditions) indicated in the production priority records RSB, among the production plan records RSA stored in the production plan table TLA for the day (herein, for the first day) (#311). All of the production plan records RSA are targets of the grouping this time, because the tentative production sequence determination portion 102 bypasses the process in Step #306.

For example, the production plan records RSA illustrated in FIG. 4 are grouped into eight groups as illustrated in thick-line frames of FIG. 7.

The tentative production sequence display control portion 103 causes the liquid crystal display 10e to display the production sequence modification screen HG1 as illustrated in FIG. 8 (#312). The production sequence modification screen HG1 indicates products corresponding to the production plan records RSA determined as a result of the process of Step #306 through Step #310 and a production sequence of the products, and products corresponding to the production plan records RSA subjected to the grouping process in Step #311 and a provisional production sequence of the products. In the case of the first day, however, the production sequence modification screen HG1 indicates only products corresponding to the production plan records RSA subjected to the grouping process in Step #311 and a provisional production sequence of the products.

An employee operates the keyboard 10f or the pointing device 10g to sort lines of the groups on the production sequence modification screen HG1. Thereby, the employee specifies which product is to be produced first, which product is to be produced second, and which product is to be produced next, and so on based on the specifications thus grouped.

Upon doing so, referring to FIG. 9, the production sequence modification reception portion 104 receives the details specified by the employee (#321). The condition data new registration portion 106 generates, based on the details, a production priority record RSB for each group (#322), and registers the production priority record RSB thus generated in the production sequence condition master TLB (#323).

For example, if the order of the eight groups is sorted as illustrated in FIG. 10, the production sequence modification reception portion 104 receives the order specified by the employee, and the condition data new registration portion 106 generates a production priority record RSB for each group, i.e., for each set of specifications, as illustrated in FIG. 11, and registers the production priority records RSB thus generated in the production sequence condition master TLB.

After the registration of the production priority records RSB, the production sequence determination portion 105 performs a process for determining a definitive (non-provisional, final or actual) production sequence. The steps of this process are basically the same as those of the process for determining a provisional production sequence.

To be more specific, referring to FIG. 12, the production sequence determination portion 105 performs an initialization process that involves resetting the values of the variables j and k to “1” (#331 and #332), and calls the production sequence condition master TLB (see FIG. 11) from the production sequence condition table storage portion 122 (#333).

The production sequence determination portion 105 searches, in the production sequence condition master TLB, for a production priority record RSB to which the first priority is given (#334). If such a production priority record RSB is found (Yes in #335), then the production sequence determination portion 105 searches, in the production plan table TLA for the day, i.e., for the first day, for a production plan record RSA including specifications identical to those of the production priority record RSB thus found (#336).

If such a production plan record RSA is found (Yes in #337), then the order of production “k-th”, i.e., herein “1^{st}”, is numbered and given to a product indicated in the production plan record RSA thus found (#338).

If a plurality of such production plan records RSA are found, sequential numbers such as “1^{st}”, “2^{nd}”, and so on are respectively given to products indicated in the plurality of such production plan records RSA thus found. A method of determining to which of the products of the production plan records RSA a smaller number is given preferentially may be determined based on prescribed rules or may be determined by the employee in each case.

The production sequence determination portion 105 increases the value of the variable k based on the quantity of numbers of the numbering process (#339).

For example, according to the production sequence condition master TLB illustrated in FIG. 11, based on the production priority record RSB indicating the value of “1” in the priority field, the production sequence determination portion 105 searches, in the production plan table TLA illustrated in FIG. 4, for a production plan record RSA indicating “28 millimeters”, “709 millimeters”, “1280 millimeters”, “black”, “silver”, “flat”, and “European style” respectively in the fields of “thickness”, “width”, “height”, “color”, “fitting”, “design”, and “series”. Consequently, production plan records RSA including the reception codes “U0001” and “U0007” respectively are searched for. The production sequence determination portion 105 assigns “1^{st}” and “2^{nd}” to such production plan records RSA respectively. Then, the production sequence determination portion 105 adds “2” to the value of the variable k, and thereby the value of the variable k is increased to “3”.

Referring back to Step #334, the production sequence determination portion 105 searches, in the production sequence condition master TLB, for a production priority record RSB to which the second priority is assigned (#334). If such a production priority record RSB is found (Yes in #335), then the production sequence determination portion 105 searches, in the production plan table TLA for the day, for production plan records RSA including specifications identical to those of the production priority record RSB thus found (#336).

If such production plan records RSA are found (Yes in #337), then sequential numbers starting from the value of the current variable k are respectively given to products indicated in the production plan records RSA thus found as with the case of the production priority record RSB to which the first priority is given (#338 and #339).

Afterwards, similarly to the case discussed above, based on the production priority records RSB to which the third priority, the fourth priority, and so on are given, numbering is performed on products indicated in production plan records RSA obtained as a result of the search (#334 through #340).

After the production sequence determination portion 105 performs numbering based on the production priority record RSB to which the lowest priority is assigned (No in #335), the production sequence display control portion 108 displays, on the liquid crystal display 10e, the production sequence screen HG2 as illustrated in FIG. 13 indicating the result of numbering on the products indicated in the production plan records RSA, i.e., the result of the determination of the production sequence (#341).

### [Steps of the Process of Determining a Production Sequence for the Second Day and Later]

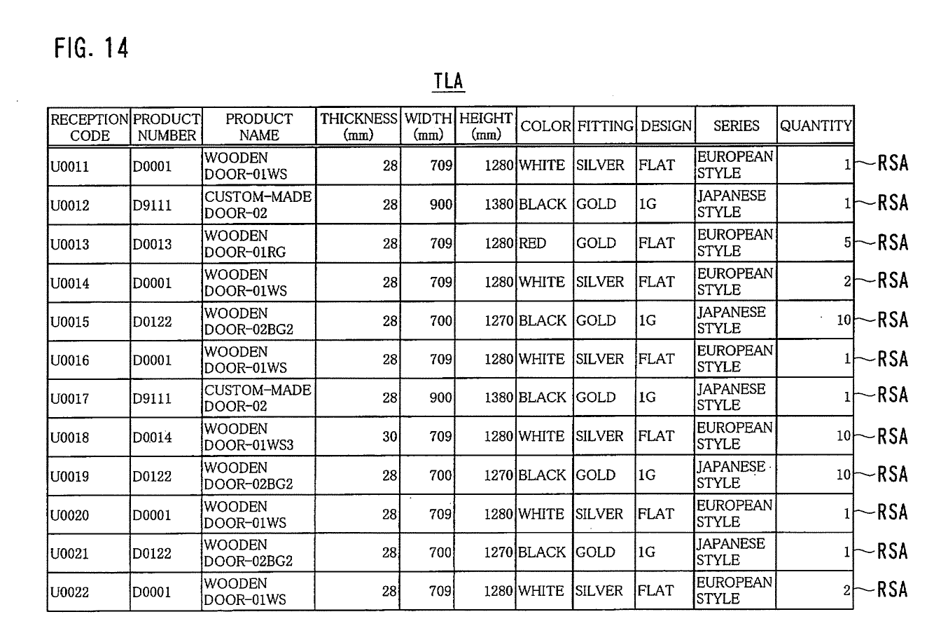

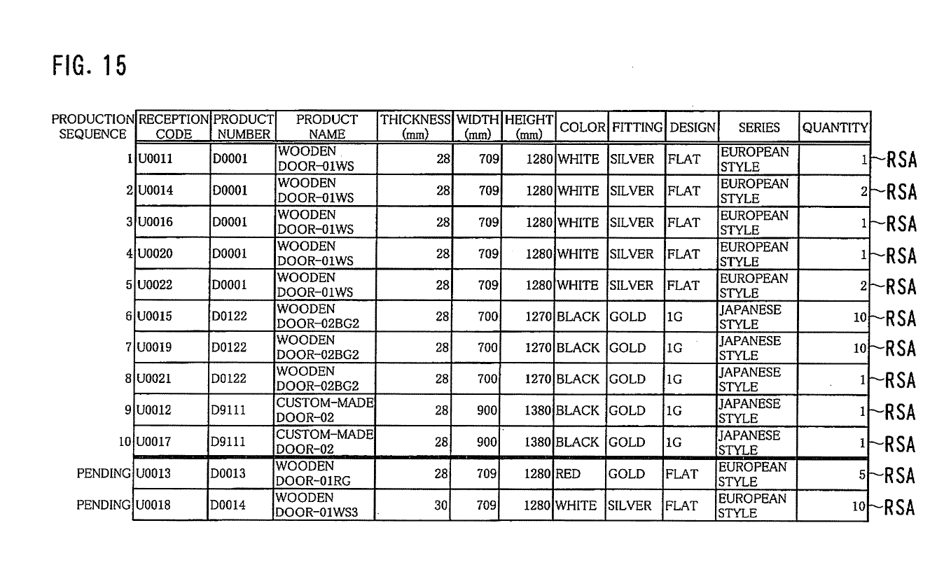

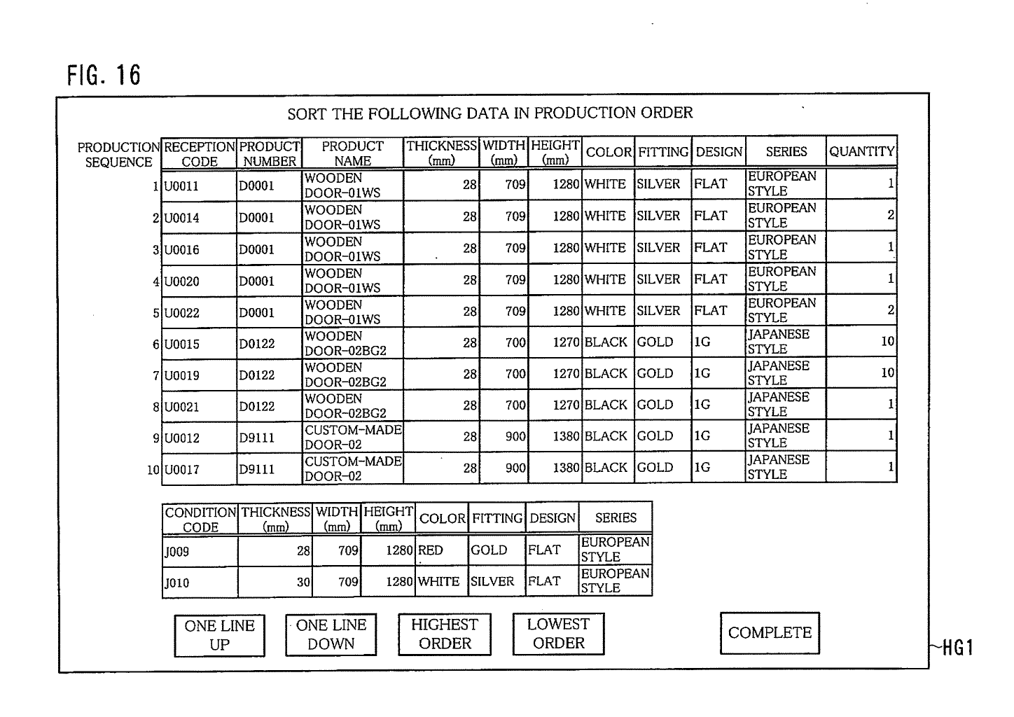

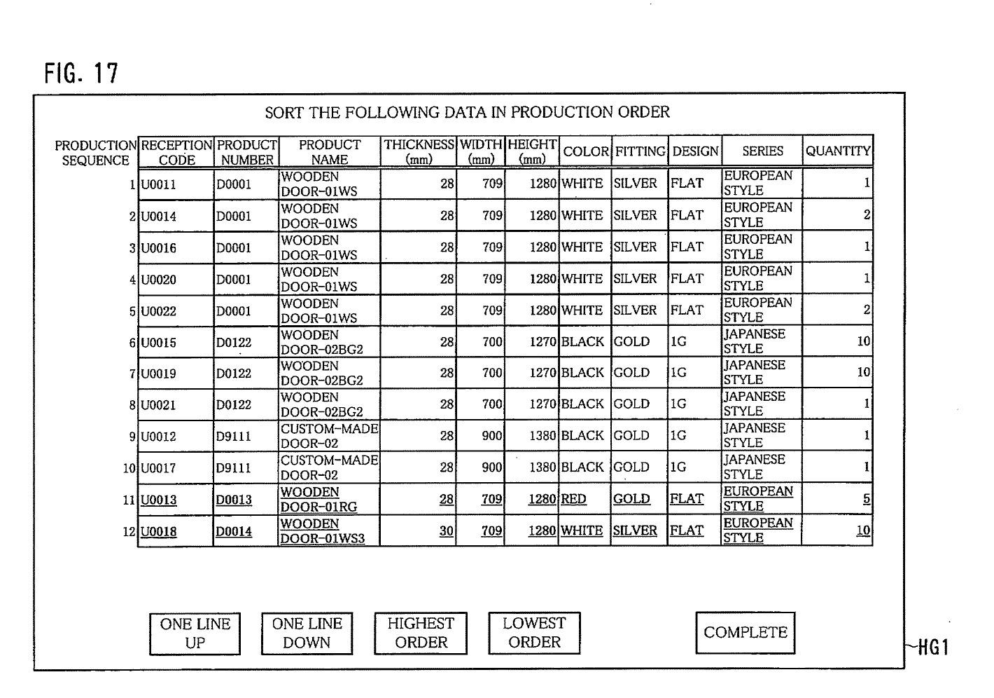

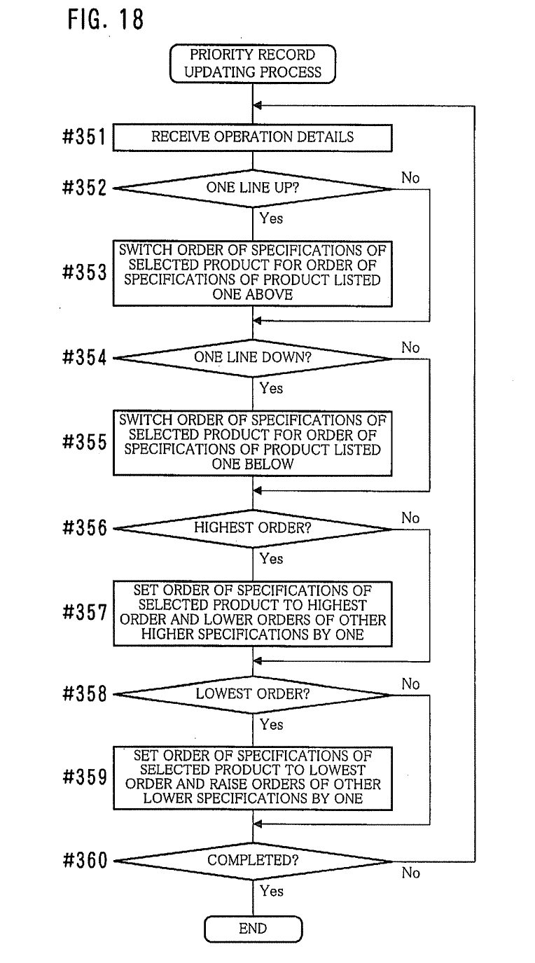

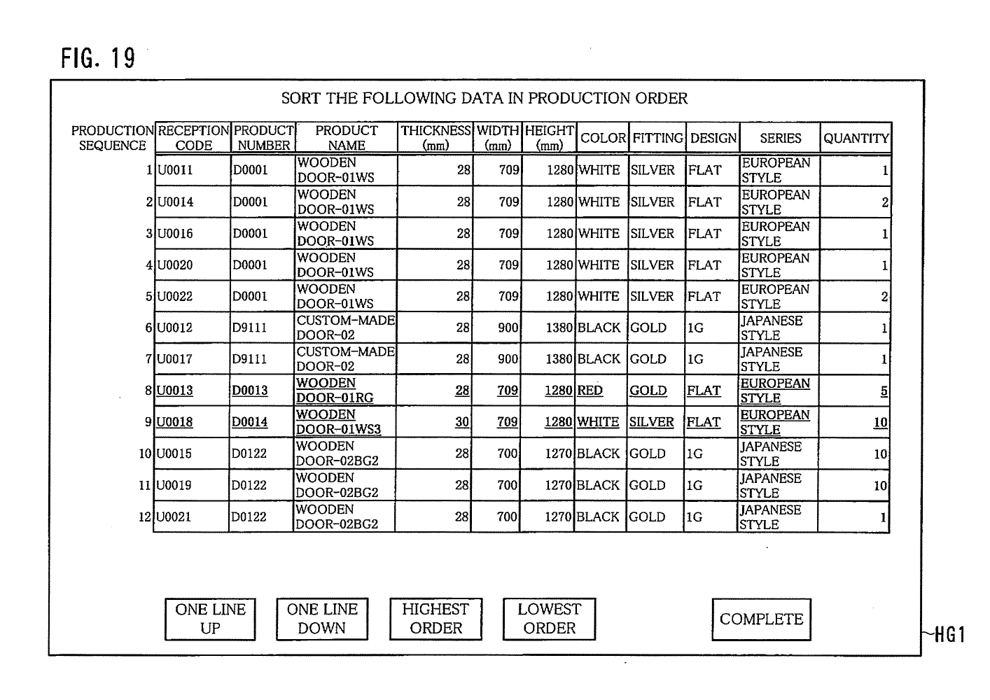

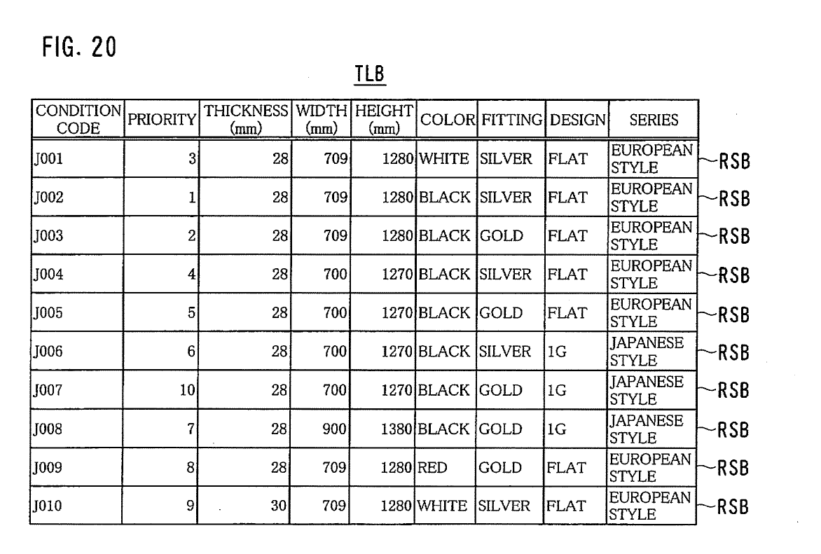

FIG. 14 is a diagram illustrating an example of the production plan table TLA; FIG. 15 is a diagram illustrating an example of a tentative production sequence; FIG. 16 is a diagram illustrating an example of the production sequence modification screen HG1; FIG. 17 is a diagram illustrating an example of a variation of the production sequence modification screen HG1; FIG. 18 is a flowchart illustrating an example of the flow of a priority record updating process; FIG. 19 is a diagram illustrating an example of sorting of production sequence by an employee; and FIG. 20 is a diagram illustrating an example of the production sequence condition master TLB.

As discussed above, the individual portions of the production sequence numbering system 1 perform a process for determining a production sequence of products for the first day mainly in the following order: extracting (grouping) types (patterns) of specifications; receiving priorities of the specifications specified by an employee; generating production priority records RSB corresponding to the specifications, and determining a production sequence of products to be produced on the first day.

As described below, the individual portions of the production sequence numbering system 1 perform a process for determining a production sequence of products for the second day and later mainly in the following order: extracting new specifications; provisionally determining a production sequence based on the existing production priority records RSB; receiving sorting of the production sequence specified by an employee; and generating or updating production priority records RSB corresponding to the specifications. Description of points common to the process for determining a production sequence of products for the first day shall be omitted.

The tentative production sequence determination portion 102 determines a provisional production sequence of products to be produced on the day in the following manner. Referring to FIG. 6, the tentative production sequence determination portion 102 performs an initialization process (#301 and #302). The tentative production sequence determination portion 102 calls the production sequence condition master TLB (see FIG. 11) from the production sequence condition table storage portion 122 (#303). Note that priorities of product specifications, which were specified by an employee on the previous day, are reflected in the production sequence condition master TLB.

The tentative production sequence determination portion 102 searches, in the production sequence condition master TLB, for a production priority record RSB to which the first priority is given (#304). If such a production priority record RSB is found (Yes in #305), then the tentative production sequence determination portion 102 searches, in the production plan table TLA for the day, for a production plan record RSA including specifications identical to those of the production priority record RSB thus found (#306).

If such a production plan record RSA is found (Yes in #307), then the order of production “k-th”, i.e., herein “1^{st}”, is numbered and given to a product indicated in the production plan record RSA thus found (#308). If a plurality of such production plan records RSA are found, sequential numbers such as “1^{st}”, “2^{nd}”, and so on are respectively given to products indicated in the plurality of such production plan records RSA thus found.

The tentative production sequence determination portion 102 increases the value of the variable k based on the quantity of numbers of the numbering process (#339), and focuses on a production priority record RSB to which the next priority is given (#310).

If no production plan records RSA including specifications identical to those of the production priority record RSB found in Step #305 are found, then the tentative production sequence determination portion 102 does not perform numbering and does not increase the value of the variable k. Then, the tentative production sequence determination portion 102 focuses on a production priority record RSB to which the next priority is given (#310).

Referring back to Step #304, the tentative production sequence determination portion 102 searches, in the production sequence condition master TLB, for a production priority record RSB to which the second priority is assigned (#304). If such a production priority record RSB is found (Yes in #305), then the tentative production sequence determination portion 102 searches, in the production plan table TLA for the day, for production plan records RSA including specifications identical to those of the production priority record RSB thus found (#306).

If such production plan records RSA are found (Yes in #307), as with the case of the production priority record RSB to which the first priority is given, the sequential numbers starting from the value of the current variable k are respectively given to products indicated in the production plan records RSA thus found (#308). Then, the tentative production sequence determination portion 102 focuses on a production priority record RSB to which the next priority is given (#310).

If no production plan records RSA including specifications identical to those of the production priority record RSB found in Step #305 are found, as with the case of the production priority record RSB to which the first priority is given, the tentative production sequence determination portion 102 does not perform numbering and does not increase the value of the variable k. Then, the tentative production sequence determination portion 102 focuses on a production priority record RSB to which the next priority is given (#310).

Afterwards, similarly to the case described above, sequentially based on the production priority records RSB to which the third priority, the fourth priority, and so on are given, numbering is performed on products indicated in production plan records RSA obtained as a result of the search (#304 through #310).

Incidentally, with the process of Step #301 through Step #310, if any of the production plan records RSA indicates a product of specifications that have never been handled since the operation of the production sequence numbering system 1 was started, i.e., a product of new specifications, numbering is not performed on such a product.

In view of this, the tentative production sequence determination portion 102 groups the specifications of such products to extract the new specifications (#311). If such new specifications are extracted, the tentative production sequence determination portion 102 performs numbering on the products of the new specifications in such a manner that the products of the new specifications come after the products corresponding to the production plan records RSA determined as a result of the process of Step #306 through Step #310. In the case, for example, where two new sets of specifications are extracted and the first priority through the eighth priority are assigned to the existing production priority records RSB, the ninth priority and the tenth priority are respectively assigned to production priority records RSB indicating the new sets of specifications.

The tentative production sequence display control portion 103 causes the liquid crystal display 10e to display the production sequence modification screen HG1 (#312). The production sequence modification screen HG1 indicates products corresponding to the production plan records RSA determined as a result of the process of Step #306 through Step #310 and a production sequence of the products, and products corresponding to the production plan records RSA subjected to the grouping process in Step #311 and a provisional production sequence of the products.

In the case, for example, where the production plan records RSA are stored in the production plan table TLA for the day as illustrated in FIG. 14, and at the same time, the production priority records RSB are stored in the production sequence condition master TLB as illustrated in FIG. 11, the production sequence of the products corresponding to the production plan records RSA is determined as illustrated in FIG. 15. As a response to this, the tentative production sequence display control portion 103 causes the liquid crystal display 10e to display the production sequence modification screen HG1 as illustrated in FIG. 16. Alternatively, instead of the information on the new specifications, information on products of the new specifications may be arranged on the production sequence modification screen HG1 as illustrated in FIG. 17.

The condition data new registration portion 106 generates a production priority record RSB for each set of new specifications. Information indicated in the production priority record RSB is the same as described earlier. However, the priority that has been determined provisionally by the tentative production sequence determination portion 102a is defined as a priority indicated in the production priority record RSB.

An employee operates the keyboard 10f or the pointing device 10g to sort lines of the products or the groups on the production sequence modification screen HG1. Thereby, the employee specifies which product is to be produced first, which product is to be produced second, and which product is to be produced next, and so on. In the case where a plurality of products having the same specifications are listed, all of such products are deemed as one group (product group) and sorted collectively. If the production sequence determined provisionally is acceptable, the employee may determine the provisional production sequence to be the definitive production sequence, and in such a case, the employee does not need to sort the products or the groups. In this way, the definitive production sequence for the day is determined.

Responding to the operation performed by the employee, the production sequence modification reception portion 104 and the condition data updating portion 107 perform a process for updating the production priority record RSB according to the procedure illustrated in FIG. 18.

The production sequence modification reception portion 104 receives the details of the production sequence specified by the employee (#351 in FIG. 18).

If the employee selects a product or a group of products having the same specifications (hereinafter such a product or such a group is referred to as simply a “product group” through the description of FIG. 17) on the production sequence modification screen HG1 illustrated in FIG. 17, and presses an “one line up” button (Yes in #352), then the condition data updating portion 107 updates the production priority record RSB of the specifications corresponding to the product group thus selected and the production priority record RSB of specifications corresponding to a product group that is listed just above (prior to) the selected product group in such a manner that the priorities of the former and the latter are switched to each other (#353).

If the employee selects a product group and presses an “one line down” button (Yes in #354), then the condition data updating portion 107 updates the production priority record RSB of the specifications corresponding to the product group thus selected and the production priority record RSB of specifications corresponding to a product group that is listed just below (posterior to) the selected product group in such a manner that the priorities of the former and the latter are switched to each other (#355).

If the employee selects a product group and presses a “highest order” button (Yes in #356), then the condition data updating portion 107 updates production priority records RSB that are listed above the product group thus selected and have specifications other than the specifications of the selected product group in such a manner that a priority of each of the production priority records RSB is lowered by one line, and further updates the production priority record RSB of specifications corresponding to the selected product group in such a manner that the highest priority is given thereto (#357).

If the employee selects a product group and presses a.“lowest order” button (Yes in #358), then the condition data updating portion 107 updates production priority records RSB that are listed below the product group thus selected and have specifications other than the specifications of the selected product group in such a manner that a priority of each of the production priority records RSB is raised by one line, and further updates the production priority record RSB of specifications corresponding to the selected product group in such a manner that the lowest priority is given thereto (#359).

The process of updating the production priority records RSB is performed in response to the operation by the employee as discussed above until a “complete” button is pressed.

For example, if the sorting is performed as illustrated in FIG. 19, and then, the “complete” button is pressed, the existing production priority records RSB are updated as illustrated in FIG. 20 and a new production priority record RSB is generated.

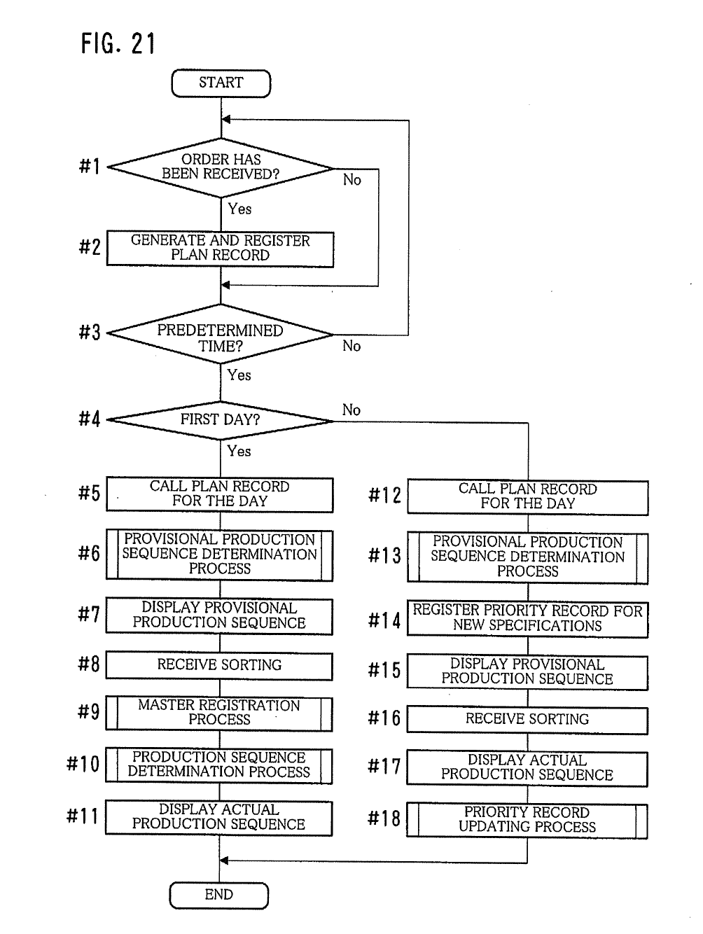

FIG. 21 is a flowchart illustrating an example of the overall processing flow of the production sequence numbering system 1.

The following is a description of the overall processing flow of the production sequence numbering system 1 for determining a production sequence of products with reference to the flowchart of FIG. 21.

Referring to FIG. 21, every time order data DTA is received (Yes in #1), the production sequence numbering system 1 determines a date on which a product indicated in the order data DTA is to be produced, and issues a unique reception code in accordance with production rules of the factory X. Then, the production sequence numbering system 1 generates a production plan record RSA indicating the reception code thus issued, a product number, a product name, specifications, and a quantity included in the order data DTA, and stores the production plan record RSA thus generated in the production plan table TLA (see FIG. 4) for the date thus determined (#2).

When a time on which a production sequence for a predetermined day is to be determined is reached (Yes in #3), the production sequence numbering system 1 performs a process for determining the production sequence.

In the case where the predetermined day is the first day (Yes in #4), the production sequence numbering system 1 performs the process according to the following manner. The production sequence numbering system 1 calls production plan records RSA for the predetermined day (#5), and determines a provisional production sequence (#6). The steps of the process for determining a provisional production sequence are the same as described earlier with reference to FIG. 6. In the case of the first day, however, priorities of specifications are determined provisionally.

The production sequence numbering system 1 displays the priorities thus determined provisionally as illustrated in FIG. 8 (#6), and receives sorting specified by an employee (#7).

The production sequence numbering system 1 generates, based on the sorting, production priority records RSB on a specification-by-specification basis, and registers the production priority records RSB thus generated in the production sequence condition master TLB (see FIG. 11) (#9). The steps of the process for the registration are the same as described earlier with reference to FIG. 9.

The production sequence numbering system 1 determines the actual production sequence for the first day based on the production priority records RSB registered in the production sequence condition master TLB (#10), and displays the determination result as illustrated in FIG. 13 (#11). The steps of the process for determining the actual production sequence are the same as described earlier with reference to FIG. 12.

On the other hand, in the case where the predetermined day is not the first day (No in #4), the production sequence numbering system 1 performs the process according to the following manner. The production sequence numbering system 1 calls production plan records RSA for that day (#12), and determines a provisional production sequence (#13). The steps of the process for determining the provisional production sequence are the same as described earlier with reference to FIG. 6. Further, the production sequence numbering system 1 generates a production priority record RSB corresponding to specifications that are ordered for the first time after the start of operation of the production sequence numbering system 1, and registers the production priority record RSB thus generated in the production sequence condition master TLB (#14). The priority of the specifications is herein set to the lowest priority. The production sequence numbering system 1 displays the determined provisional production sequence as illustrated in FIG. 17 (#15), and receives sorting specified by an employee (#16).

The production sequence numbering system 1 displays a production sequence sorted by the employee (#17), and updates the priorities of the production priority records RSB of the specifications based on the production sequence obtained as a result of the sorting (#18). The steps of the process for updating the priorities are the same as described earlier with reference to FIG. 18.

This embodiment makes it possible for an employee to maintain the production sequence condition master TLB on a daily basis while he/she performs a task of determining a production sequence of products. This enables the employee to obtain an appropriate production sequence of products with a simple operation. Further, even when the number of attributes of a product is large, a preferable production sequence of products is obtained more easily than is conventionally possible.

In this embodiment, the case in which a production sequence condition master TLB is generated from the beginning is described. Instead, however, the existing production sequence condition master TLB may be used. Supposing, for example, that a factory Y is newly built and a production sequence numbering system 1 for the factory Y is introduced. In such a case, the production sequence numbering system 1 for the factory Y may use a duplicate of the production sequence condition master TLB included in the production sequence numbering system 1 for the factory X.

In this embodiment, the description is given of the case of determining a production sequence of doors. Instead, the embodiment is also applicable to the case of determining a production sequence of other products.

In the embodiment discussed above, the overall configuration of the production sequence numbering system 1, the configurations of various portions thereof, the content to be processed, the processing order, the details of the various tables, the details of the various masters and the like may be altered as required in accordance with the subject matter of the present invention.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A production sequence determination support method for determining a production sequence of a plurality of first products to be produced, the production sequence determination support method comprising:
causing a computer to perform
determining types of specifications of the plurality of first products,
displaying a screen for a user to specify individual priorities for the types of specifications, each of the priorities of the types of specifications being to produce one or more of the plurality of first products having the type of specifications,
storing the priorities of the types of specifications specified by the user,
determining the production sequence of the plurality of first products by sorting the plurality of first products in descending order of the priorities of the types of specifications thus stored, and
displaying the production sequence of the plurality of first products thus determined.

2. The production sequence determination support method according to claim 1, wherein the computer is caused to perform
determining types of specifications of a plurality of second products to be produced in a period different from a period in which the plurality of first products are to be produced,
determining a provisional production sequence of the plurality of second products by sorting the plurality of second products in descending order of the priorities of the types of specifications that have been previously stored, and at the end, by arranging the plurality of second products that do not fall within any of the types of specifications,
displaying the provisional production sequence of the plurality of second products thus determined to allow the user to specify an actual production sequence of the plurality of second products,
displaying the actual production sequence, specified by the user, of the plurality of second products, and
updating the priorities of the types of specifications that have been previously stored based on the actual production sequence, specified by the user, of the plurality of second products.

3. A production sequence determination support device for determining a production sequence of a plurality of products to be produced, the production sequence determination support device comprising:
a type determination section that determines types of specifications of the plurality of products;
a specification screen display that displays a screen for a user to specify individual priorities for the types of specifications, each of the priorities of the types of specifications being to produce one or more of the plurality of products having the type of specifications;
a priority storage that stores the priorities of the types of specifications specified by the user;
a production sequence determination section that determines the production sequence of the plurality of products by sorting the plurality of products in descending order of the priorities of the types of specifications stored in the priority storage; and
a production sequence display that displays the production sequence of the plurality of products thus determined.

4. A computer-readable storage medium storing thereon a computer program for controlling a computer performing a process for determining a production sequence of a plurality of products to be produced, the computer program causing the computer to perform:
determining types of specifications of the plurality of products;
displaying a screen for a user to specify individual priorities for the types of specifications, each of the priorities of the types of specifications being to produce one or more of the plurality of products having the type of specifications;
storing the priorities of the types of specifications specified by the user;
determining the production sequence of the plurality of products by sorting the plurality of products in descending order of the priorities of the types of specifications thus stored; and
displaying the production sequence of the plurality of products thus determined.
